(19) United States
(12) Patent Application Publication
(10) Pub. No.: US 2016/0001562 A1
(43) Pub. Date: Jan. 7, 2016

(54) METHOD OF MAINTAINING PRINTHEAD USING MOVABLE CARRIAGE

(71) Applicant: Memjet Technology Limited, Dublin (IE)

(72) Inventors: Vesa Karpinnen, Balmain (AU); Garry Raymond Jackson, Balmain (AU)

(21) Appl. No.: 14/853,692

(22) Filed: Sep. 14, 2015

Related U.S. Application Data
(63) Continuation of application No. 13/283,577, filed on Oct. 28, 2011.

(51) Int. Cl. B41J 2/165

(52) U.S. Cl. CPC B41J 2/16535

(57) ABSTRACT

A method for maintaining an elongate stationary printhead includes the steps of: moving a carriage lengthwise along the elongate stationary printhead, the carriage having a roller urged against the printhead and a strip of absorbent material around the roller, such that the printhead is wiped by the absorbent material during movement of the carriage; extending the strip of absorbent material lengthwise along the elongate stationary printhead during movement of the carriage, such that the strip of absorbent material opposes nozzles in the printhead; and ejecting ink from the nozzles onto the strip of absorbent material.

### FIELD OF THE INVENTION

The present invention relates generally to ink jet printing and, in particular, to a system for maintaining a page-width ink jet print head.

### BACKGROUND

A print head of a page-width ink jet printer typically contains thousands of very small closely arranged nozzles. The diameter of a typical nozzle aperture is in the order of 15 μm. The print head is in close contact with a substrate, such as a sheet of paper, being printed on. Debris on the substrate, such as lint or stray paper fibers, is often picked up by the print head. The debris may block nozzles on the print head, preventing those nozzles from ejecting ink. More usually, debris overlies nozzles and partially covers nozzle apertures. Nozzle apertures that are partially covered or blocked produce misdirected ink droplets during printing.

Another cause for nozzles to cease proper operation is when the ink in the nozzles dries. Drying ink causes the pigments and dyes to dry out, thereby forming a viscous mass, or even a solid mass, that blocks the ink passageways and nozzles Ink drying may affect the print head as a whole, for example when the entire print head has not been used for some time, or may also affect individual nozzles when such nozzles have not ejected ink for some time.

Failure of even a single nozzle may cause a visible effect on the printed output by the print head. The effect is typically a blank line across the printed output. Proper cleaning of the print head is therefore essential to providing a quality printed output from a print head.

To improve the reliability of print heads, most printers include a “maintenance station”. The maintenance station typically includes a flexible blade. Typically the print head slides into the maintenance station, and contacts the flexible blade which is arranged to wipe any contaminants off the front face of the print head. When nozzles are clogged, the printer attempts to fire all nozzles at once. Some of the ink generally wicks across the print head. The flexible blade is wiped across the print head to spread the ink evenly across the print head, thereby covering nozzles containing dried ink. The dried ink in those nozzles is rehydrated by the ink swept across the print head, and the nozzles are again all fired to dislodge any ink clumps blocking the nozzles.

A need exists for an improved maintenance mechanism for cleaning print heads.

### SUMMARY

It is an object of the present invention to substantially overcome, or at least ameliorate, one or more disadvantages of existing arrangements.

According to an aspect of the present disclosure, there is provided a system for maintaining an elongate stationary print head, the system comprising:

first and second reels;

a carriage movable lengthwise along the elongate stationary print head, the carriage having a roller urged against the print head during movement in at least one direction;

a strip of material fed from the first reel, around the roller of the carriage and onto the second reel; and

means for moving the carriage lengthwise along the elongate stationary print head causing the strip around the roller of the carriage to wipe the print head when the roller is urged against the print head.

According to another aspect of the present disclosure, there is provided a capper-platen for a stationary print head, the capper-platen comprising:

a platen arranged below the stationary print head, the platen being movable towards and away from the print head;

a capper having a perimeter gasket, the perimeter gasket being arranged around the platen and movable towards and away from the print head, the movement of the capper being co-axial to movement of the platen and independent from the movement of the platen, the perimeter gasket sealing the stationary print head when moved against the stationary print head; and

an actuator for selectively moving the capper and the platen towards and away from the print head.

Other aspects of the invention are also disclosed.

### BRIEF DESCRIPTION OF THE DRAWINGS

One or more embodiments of the present invention will now be described with reference to the drawings, in which:

FIGS. 1 and 2 illustrate a wiping system wiping debris from a print head;

FIG. 3 illustrates the wiping system being used by the print head for purging ink in order to dislodge dried ink and debris;

FIG. 4 illustrates a configuration of a combined capper-platen during printing;

FIG. 5 illustrates the configuration of the combined capper-platen while the combined capper-platen caps the print head; and

FIGS. 6 to 10 show various isometric views of the print head maintenance system in different stages of movement;

FIGS. 11 to 15 show isometric views of an arrangement for actuating the combined capper-platen, and parts thereof;

FIG. 16 shows a cross-sectional view of the combined capper-platen; and

FIGS. 17 to 20 illustrate an alternative arrangement for selectively winding a microfiber strip onto and from a supply reel and a take-up reel.

### DETAILED DESCRIPTION INCLUDING BEST MODE

Where reference is made in any one or more of the accompanying drawings to features which have the same reference numerals, those features have for the purposes of this description the same function(s) or operation(s), unless the contrary intention appears.

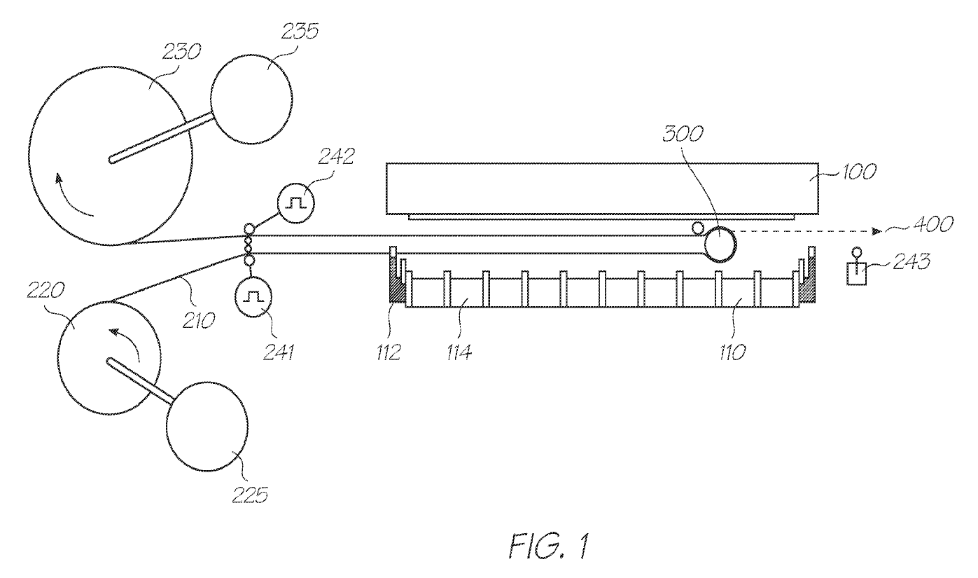

FIGS. 1 to 5 illustrate the basic structure and the principle of operation of a print head maintenance system according to an aspect of the present disclosure. The print head maintenance system provides a combined capper-platen 110 for capping a page-width ink-jet print head 100 and for providing a platen used by the print head 100 during printing. The print head maintenance system further provides a wiping system used by the print head 100 during purging as well as for wiping debris from the print head 100.

The combined capper-platen 110 is positioned below the print head 100. Not clearly visible in FIGS. 1 to 5, but as would be described in detail below, the combined capper-platen 110 has a platen portion 114, and a capper portion 112 slidably arranged around the platen portion 114. The capper portion 112 and the platen portion 114 are independently movable towards and away from the printing face of the print head 100 by an actuator.

Referring to FIG. 1, the wiping system is positioned adjacent the print head 100, and includes a supply reel 220 and a take-up reel 230. A microfiber strip 210 is wound upon the supply reel 220 and is spooled off onto the take-up reel 230. The microfiber strip 210 is fed through rollers of a wiping carriage 300. The rollers of the wiping carriage 300 are free rolling. The wiping carriage 300 slides along a track (not illustrated in FIGS. 1 to 5) longitudinally along the length of and below the printing face of the print head 100.

A spring arrangement 400 pulls the carriage 300 along its track in a direction away from the side the reels 220 and 230 are positioned. One or more motors are used to selectively wind the strip onto and from the reels 220 and 230. In the embodiment described with reference to FIGS. 1 to 5, motors 225 and 235 drive the supply reel 220 and the take-up reel 230 respectively. Accordingly, by controlling the winding and unwinding of the supply reel 220 and the take-up reel 230 through control of motors 225 and 235 by a microprocessor (not illustrated), the positioning of the carriage 300 is controlled. The wiping system further includes two rotation sensors 241 and 242 for sensing the rate of winding and unwinding of the microfiber strip 210 from the supply reel 220 and the take-up reel 230 respectively. A position sensor 243 is also included for sensing when the carriage 300 reaches an opposite longitudinal end of the print head 100.

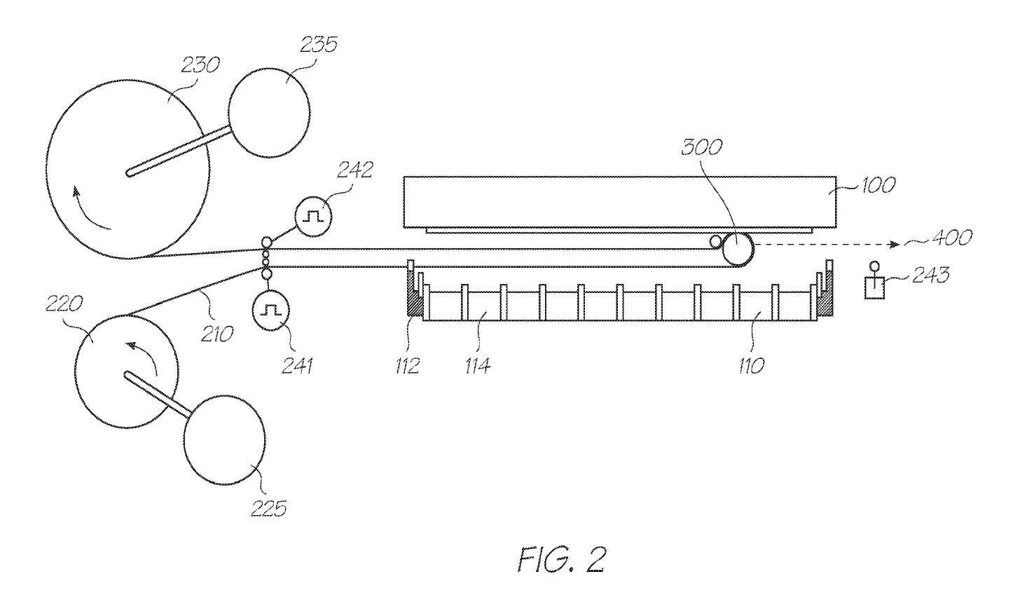

FIGS. 1 and 2 illustrate the wiping system wiping debris from the print head 100. FIG. 1 illustrates the carriage 300 moving along its track from the side where the reels 220 and 230 are positioned to the opposite longitudinal end of the print head 100. The capper portion 112 and the platen portion 114 are positioned away from the print face of the print head 100. The motors 225 and 235 are controlled to unwind the microfiber strip 210 from the supply reel 220 and the take-up reel 230 simultaneously, while the carriage 300 is pulled by the spring arrangement 400 from the side where the reels 220 and 230 are positioned to the opposite longitudinal end of the print head 100. The rollers of the carriage 300 are positioned away from the print face of the print head 100, preventing the microfiber strip 210 contacting the print face of the print head 100.

As is illustrated in FIG. 2, after the carriage 300 moved past the print head 100, signalled by the carriage 300 triggering the position sensor 243, the rollers of the carriage 300 are moved upwards, level with the print face of the print head 100. The motors 225 and 235 are then controlled to wind the microfiber strip 210 onto the supply reel 220 and the take-up reel 230 simultaneously, in order to move the carriage 300 in a direction towards the side of where the reels 220 and 230 are positioned. The microfiber strip 210, wrapped over one of the rollers of the carriage 300, urges against the print face of the print head, and wipes the print face of the print head 100 during the movement of the carriage 300 towards the side the reels 220 and 230 are positioned. The motors 225 and 235 act against the pull force of the spring arrangement 400 and against friction of the microfiber strip 210 against the print face of the print head 100. The motors 225 and 235 are controlled to move the carriage 300 at a constant speed towards the side the reels 220 and 230 and clear from the print head 100.

The motors 225 and 235 are preferably controlled such that the microfiber strip 210 remains stationary relative to the rollers of the carriage 300, causing the portion of the microfiber strip 210 wiping the print face of the print head 100 to remain unchanged during the wipe. Also, through control of the motors 225 and 235 between subsequent wipes, the portion of the microfiber strip 210 wiping the print face of the print head 100 is changed.

In an alternative implementation the motors 225 and 235 are controlled such that the microfiber strip 210 moves very slowly relative to the rollers of the carriage 300, causing the portion of the microfiber strip 210 wiping the print face of the print head 100 to changed gradually during the wipe.

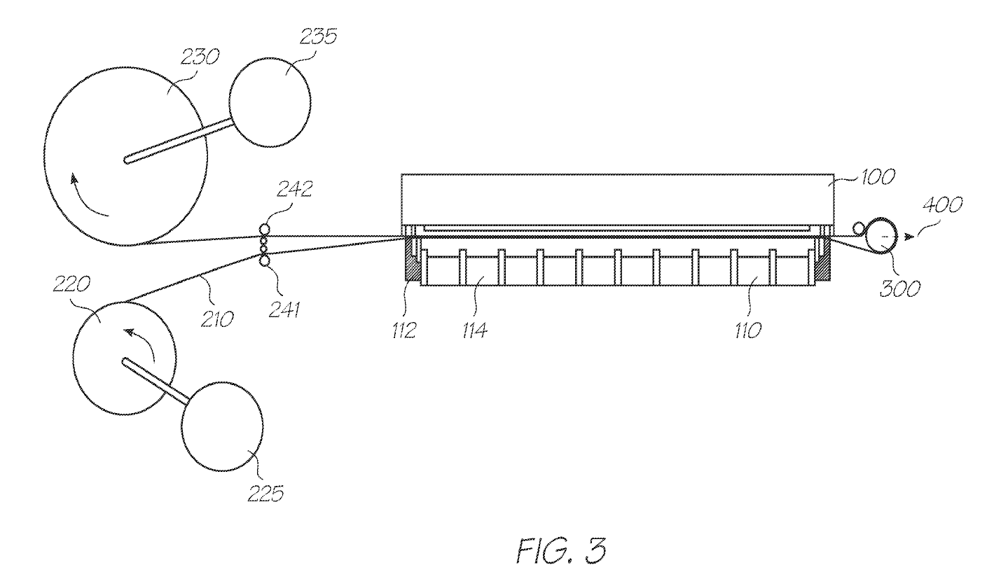

FIG. 3 illustrates the wiping system being used by the print head 100 for purging ink from its nozzles in order to dislodge dried ink and debris from the nozzles. After the carriage 300 moved past the print head 100 as discussed above with reference to FIG. 1, the capper portion 112 of the combined capper-platen 110 is moved upwards in order to cap the print head 100, thereby capturing the microfiber strip 210 between the capper portion 112 and the print head 100. The print head 100 is next controlled to eject ink from all its nozzles. The ejected ink is ejected onto the microfiber strip 210 where the ink is absorbed.

After the print head 100 is purged, the capper portion 112 of the combined capper-platen 110 is moved away from the print head 100, and the motors 225 and 235 are controlled to wind the microfiber strip 210 onto the supply reel 220 and the take-up reel 230 simultaneously, in order to move the carriage 300 in the direction towards the side the reels 220 and 230 are positioned, while wiping the print face of the print head 100 in the manner described with reference to FIG. 2.

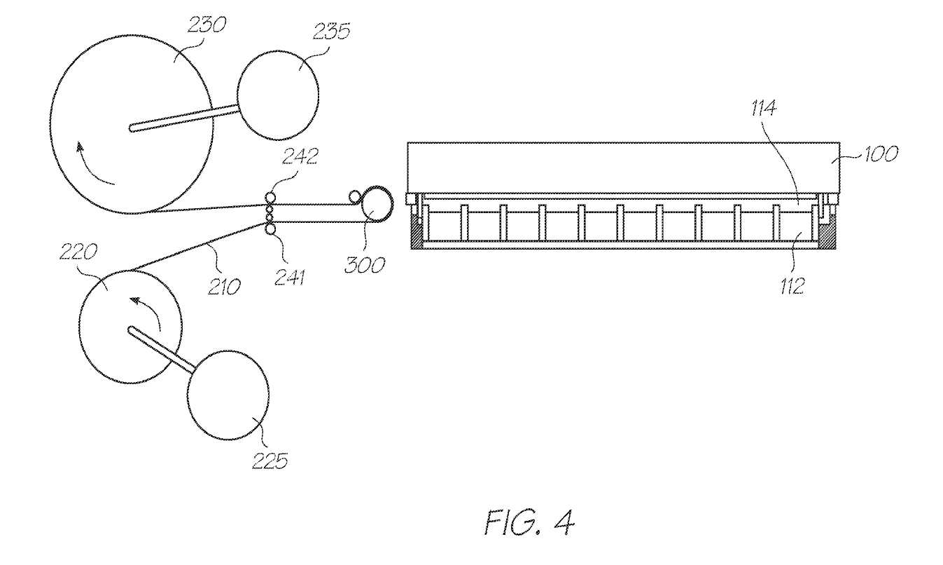

FIG. 4 illustrates the platen portion 114 of the combined capper-platen 110 in a raised position while the capper portion 112 is in a position away from the print head 100. The configuration illustrated in FIG. 4 is used during printing when paper sheets are fed through a gap provided between the print face of the print head 100 and the platen portion 114, while the print head 100 prints on the paper sheets. The wiping system is in-operative during this configuration.

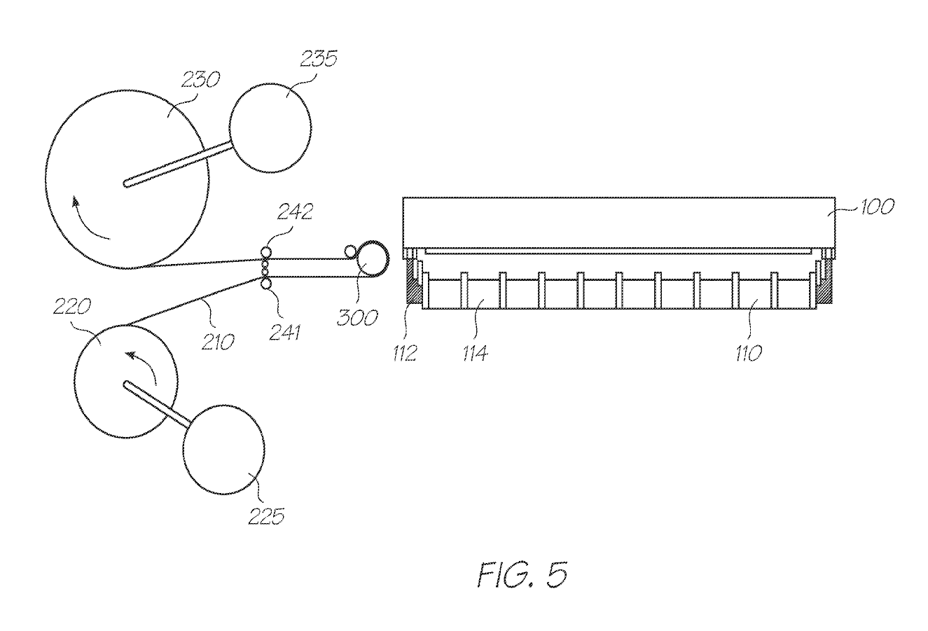

FIG. 5 illustrates the capper portion 112 of the combined capper-platen 110 in a raised position while the platen portion 114 is in a position away from the print head 100. A perimeter gasket of the capper portion 112 is urged against the print head 100, thereby forming a sealed chamber around the nozzles of the print head 100. The sealed chamber prevents ink within the nozzles from drying. The wiping system is in-operative during this configuration.

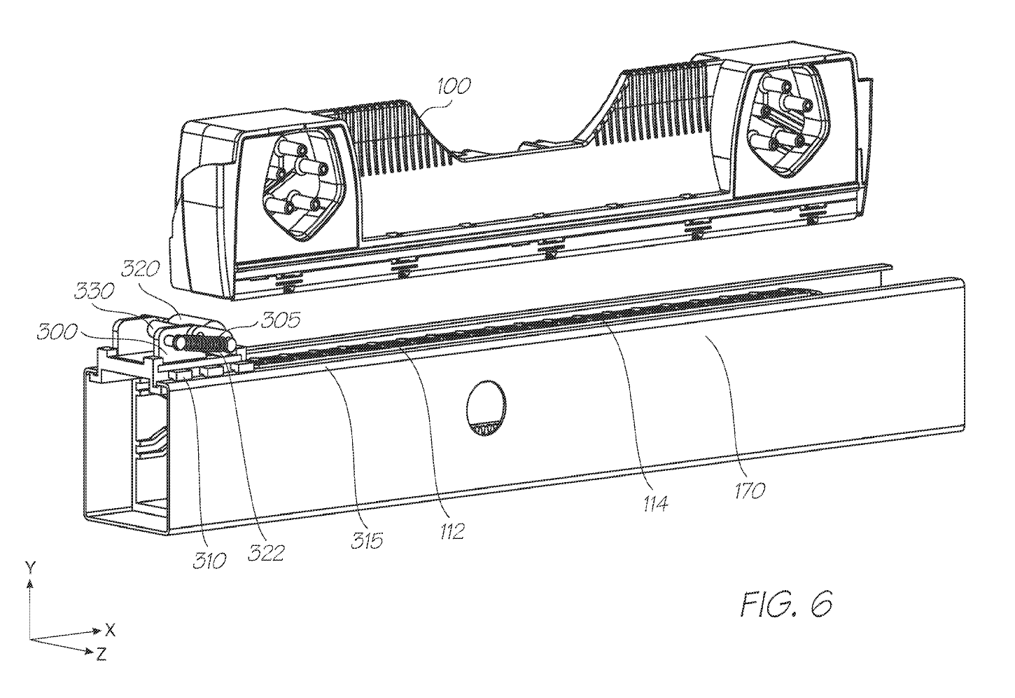

FIGS. 6 to 10 show various isometric views of the print head maintenance system according to an aspect of the present disclosure. In order to improve clarity certain elements of the print head maintenance system are not shown, such as the supply reel 220, the take-up reel 230, the microfiber strip 210, spring arrangement 400 and sensors 241, 242 and 243.

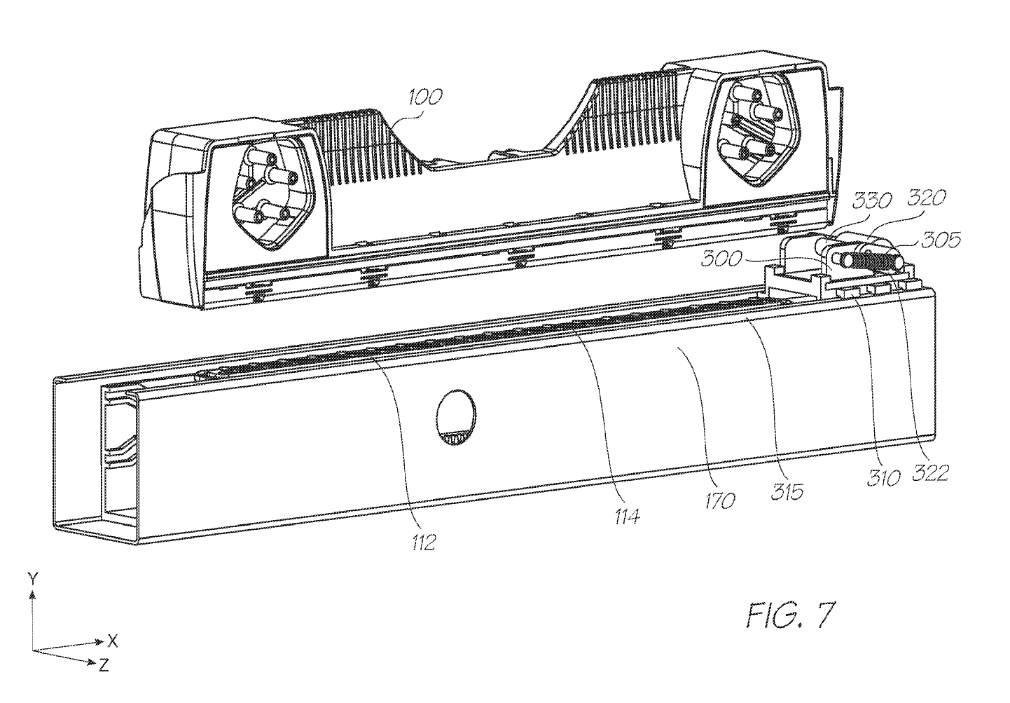

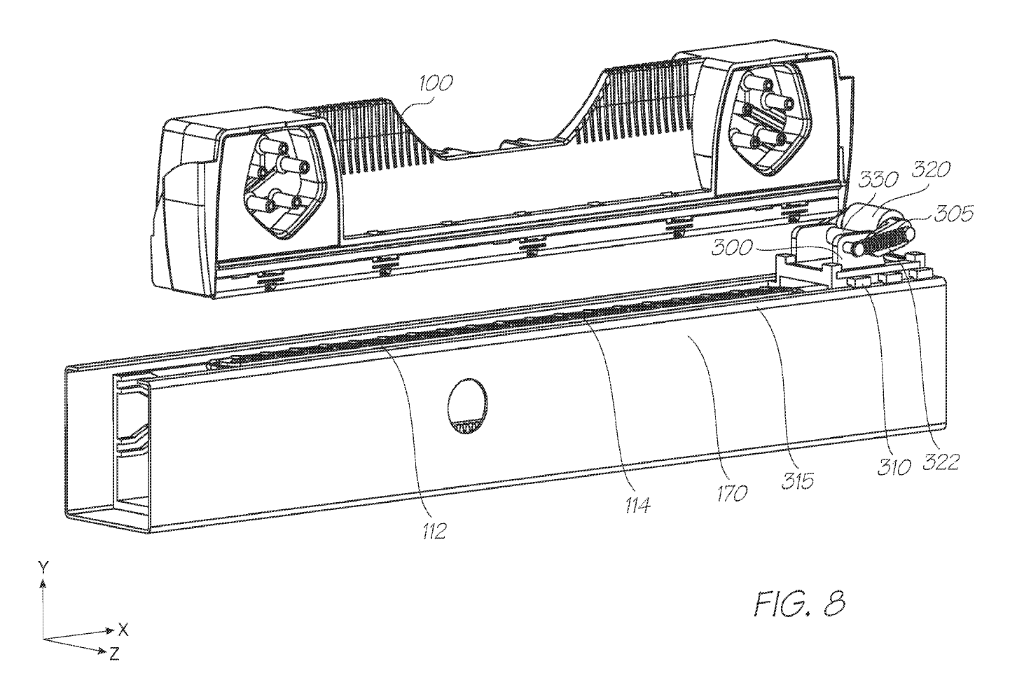

FIG. 6 shows the combined capper-platen 110 positioned below the print head 100. In the configuration shown in FIG. 6 both the capper portion 112 and the platen portion 114 are in a position away from the printing face of the print head 100. The wiping carriage 300 is also shown in more detail. The wiping carriage 300 has guides 310 for engaging a track 315 enabling the wiping carriage 300 to slide along the track 315 along the length of and below the printing face of the print head 100. Roller 320 is on a spring loaded rocker lever system 322. In FIGS. 6 and 7 the roller 320 is shown in a lowered position, whereas in FIGS. 8 to 10 the roller 320 is shown in a raised position. By applying a raising force to the roller 320, the roller 320 transitions from the lowered position to the raised position and is held in the raised position by spring 305. Similarly, by applying a lowering force to the roller 320, the roller 320 transitions from the raised position to the lowered position and is held in the lowered position by the spring 305.

A second roller 330 is also provided around the axis of the rocker lever system 322. The microfiber strip 210 (not illustrated in FIGS. 6 to 10) is guided around roller 320 and below roller 330. Accordingly, when the roller 320 is in the raised position, as is shown in FIGS. 8 to 10, the microfiber strip 210 contacts the print face of the print head 100, whereas when the roller 320 is in the lowered position, as is shown in FIGS. 6 and 7, the microfiber strip 210 does not contact the print face of the print head 100.

FIG. 7 shows the wiping carriage 300 having moved nearly to the end of its passage along track 315 to the opposite longitudinal end of the print head 100 to the position of the carriage 300 shown in FIG. 6. The capper portion 112 and the platen portion 114 are positioned away from the print face of the print head 100. The roller 320 is still in the lowered position. Accordingly, during the movement of the carriage 300 from the configuration shown in FIG. 6 to that shown in FIG. 7, contact with the print face of the print head 100 is avoided. FIG. 8 shows the wiping carriage 300 having moved beyond the position shown in FIG. 7 and past the print head 100. The rocker lever system 322 contacts a cam (not illustrated) which applies a raising force to the roller 320, transitioning the roller 320 from the lowered position to the raised position.

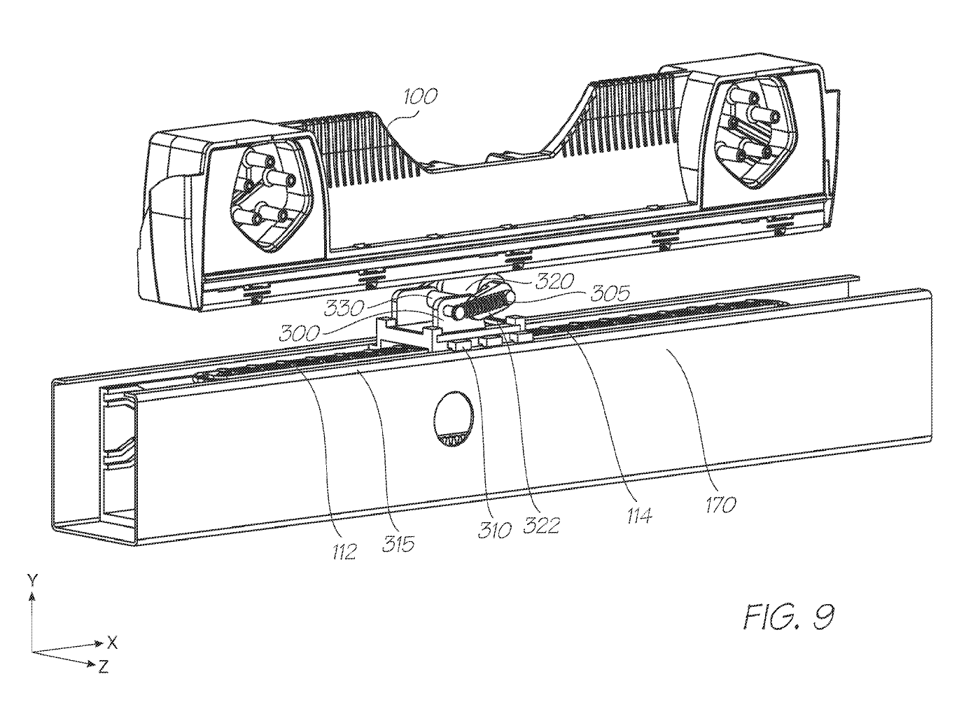

FIG. 9 shows the configuration corresponding to that illustrated in FIG. 2. As is discussed in detail with reference to FIG. 2, the motors 225 and 235 (illustrated in FIGS. 1 to 5) are controlled in order to pull the carriage 300 back towards the reels 220 and 230 (illustrated in FIGS. 1 to 5), and since the roller 320 is in the raised position, the microfiber strip 210 wrapped over the roller 320 wipes the print face of the print head 100.

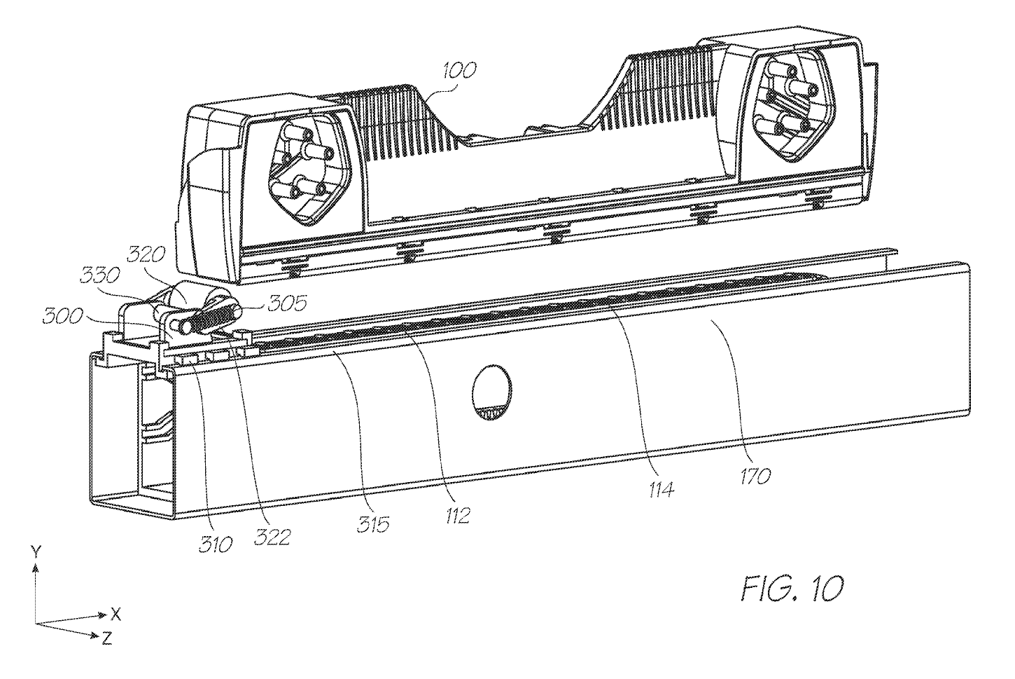

Upon the wiper carriage 300 reaching the position shown in FIG. 10, the rocker lever system 322 contacts another cam (not illustrated) which applies a lowering force to the roller 320, transitioning the roller 320 from the raised position to the lowered position. With the roller 320 again being in the lowered position, the wiping system is restored to the configuration shown in FIG. 6.

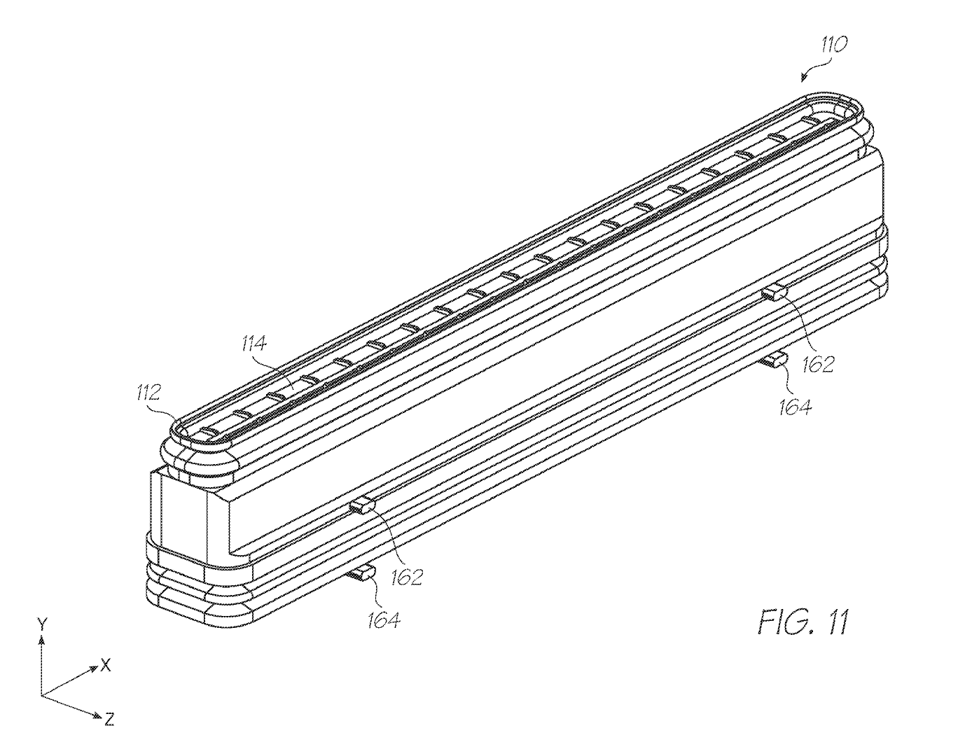

An embodiment of the actuator which independently moves the capper portion 112 and the platen portion 114 towards and away from the printing face of the print head 110 is now described with reference to FIGS. 11 to 15. FIG. 11 shows an isometric view of the combined capper-platen 110 with the platen portion 114 being arranged inside the capper portion 112. A part of the platen portion 114 extends below the capper portion 112. Each of the capper portion 112 and the platen portion 114 has guides 162 and 164 extending therefrom.

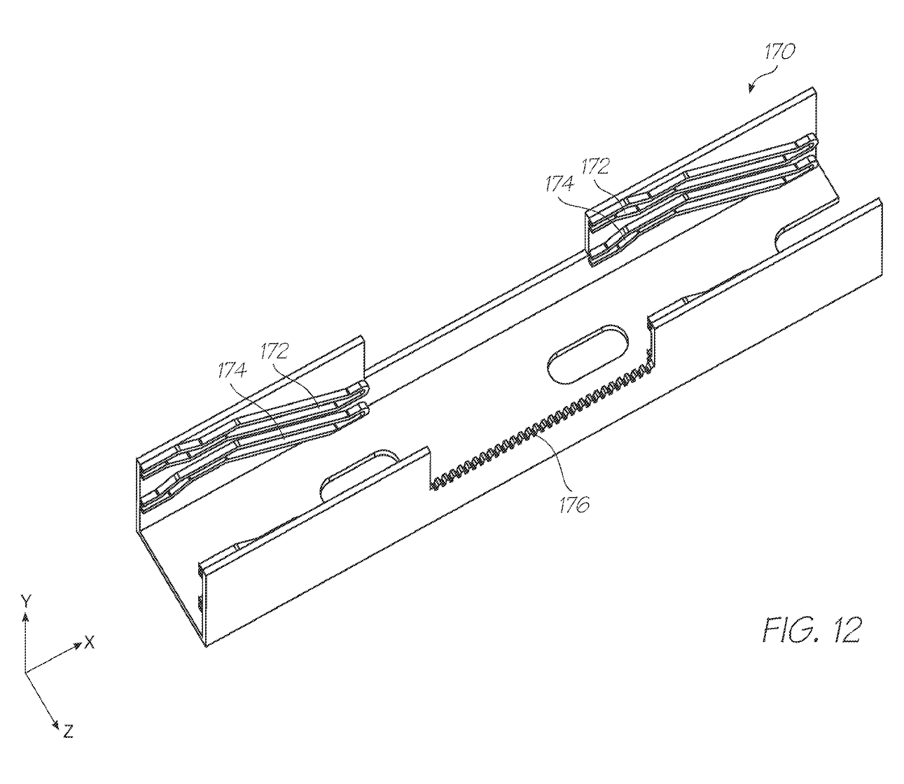

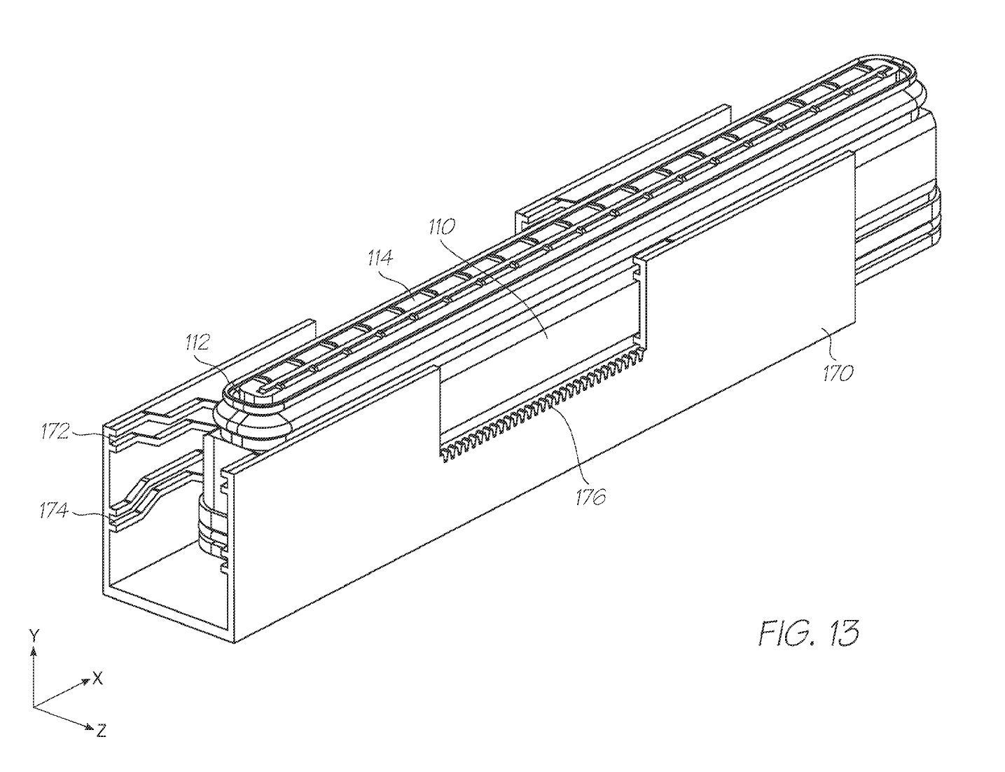

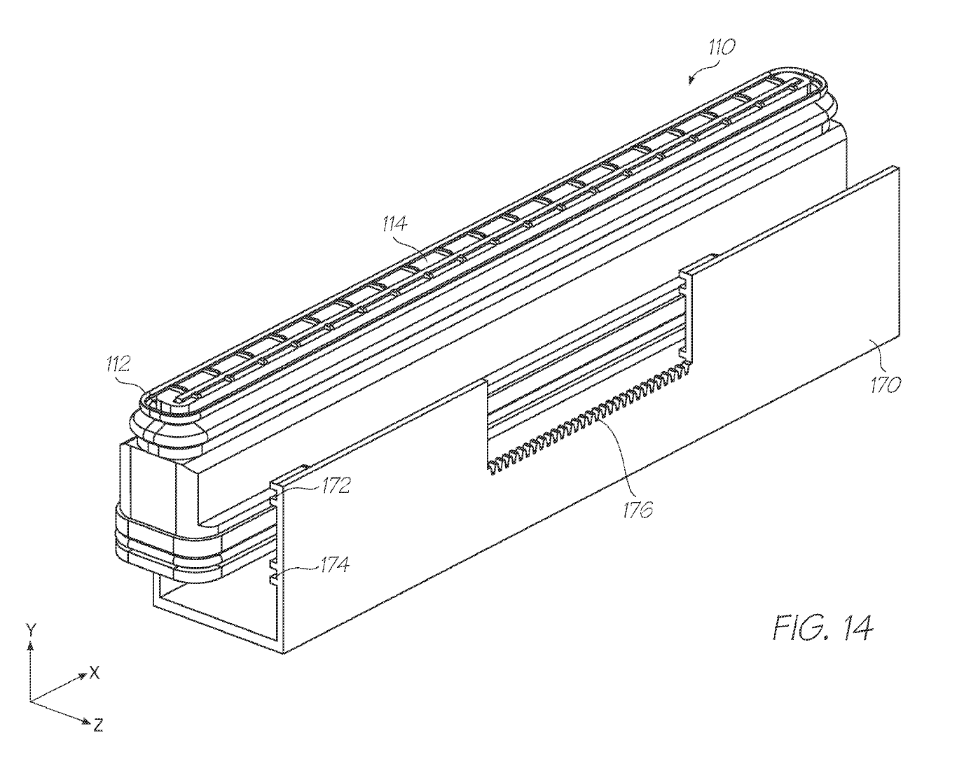

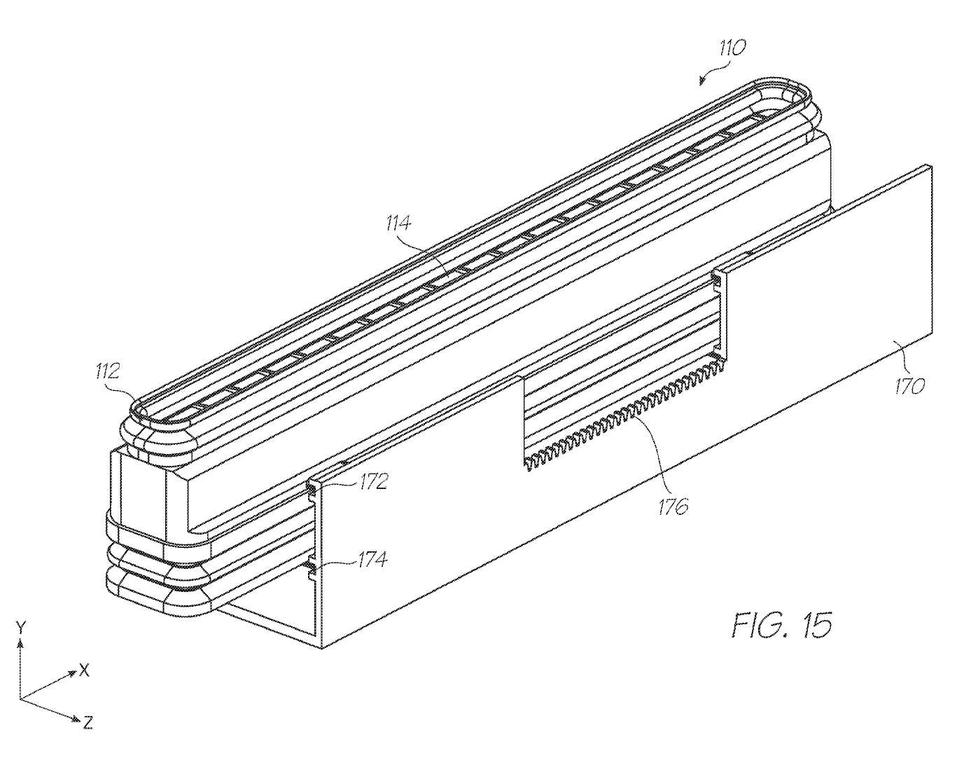

FIG. 12 shows an isometric view of the track arrangement 170. The track arrangement 170 has profiled tracks 172 and 174 for slidably receiving the guides 162 and 164 of the capper portion 112 and the platen portion 114 respectively. The track arrangement 170 also has a gear rack 176, allowing a motor (not illustrated), under control of a micro-processor (not illustrated), to move the track arrangement 170 back and forth in a direction along the longitudinal length of the combined capper-platen 110, ie. along the x-axis. Movement of the track arrangement 170 along the x-axis causes movement of the capper portion 112 and the platen 114 along the y-axis, and dependent upon the positioning of the track arrangement 170, either both the capper portion 112 and the platen portion 114 are in a position away from the printing face of the print head 110, or either of the capper portion 112 or the platen portion 114 is positioned against or adjacent the print face of the print head 100. In the configuration shown in FIG. 13 both the capper portion 112 and the platen portion 114 are in a position away from the printing face of the print head 100. In the configuration shown in FIG. 14 the platen portion 114 is in a printing position close to the print head 100, while the capper portion 112 is spaced from the print head 100. In the configuration shown in FIG. 15 the capper portion 112 is urged against the print face of the print head 100, while the platen portion 114 is spaced from the print head 100.

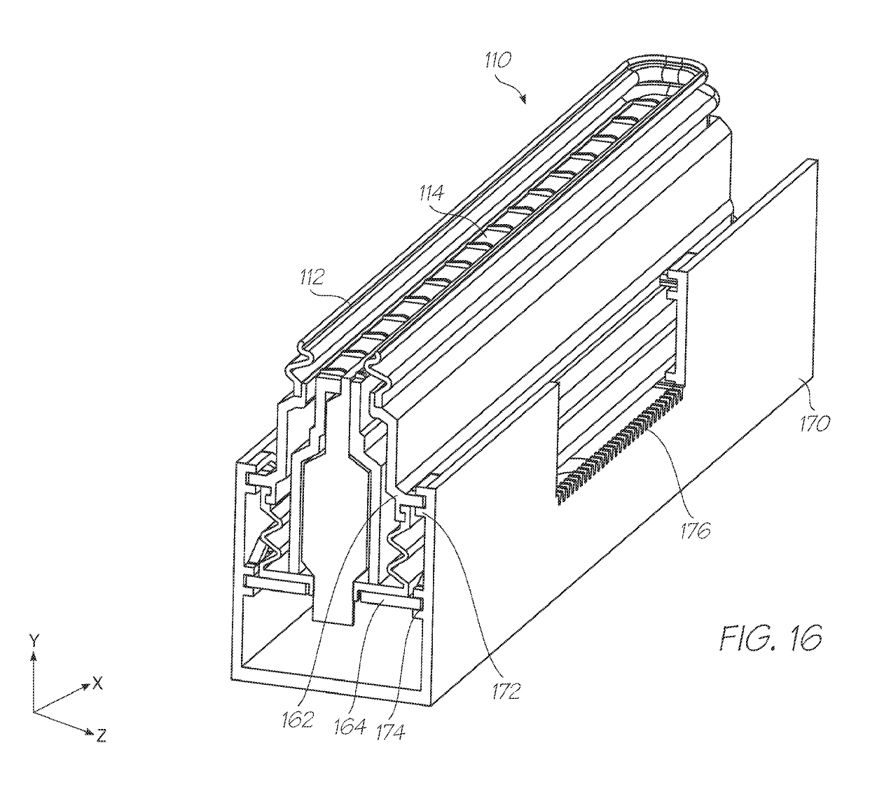

FIG. 16 shows a cross-sectional view of the combined capper-platen 110 showing the manner in which the capper portion 112 is slidably arranged around the platen portion 114. The interaction between tracks 172 and 174 and the associated guides 162 and 164 to move the capper portion 112 and the platen portion 114 respectively are also shown.

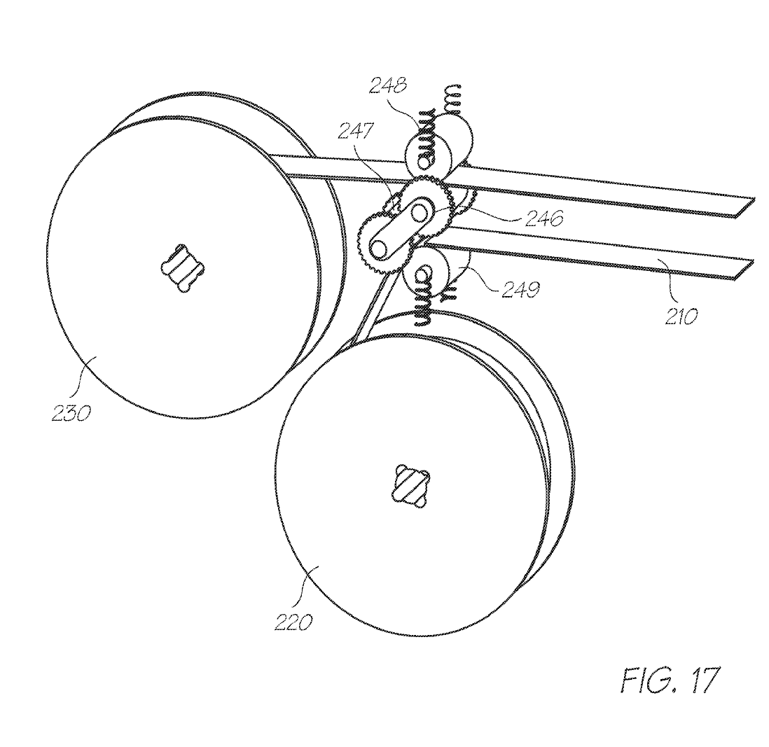

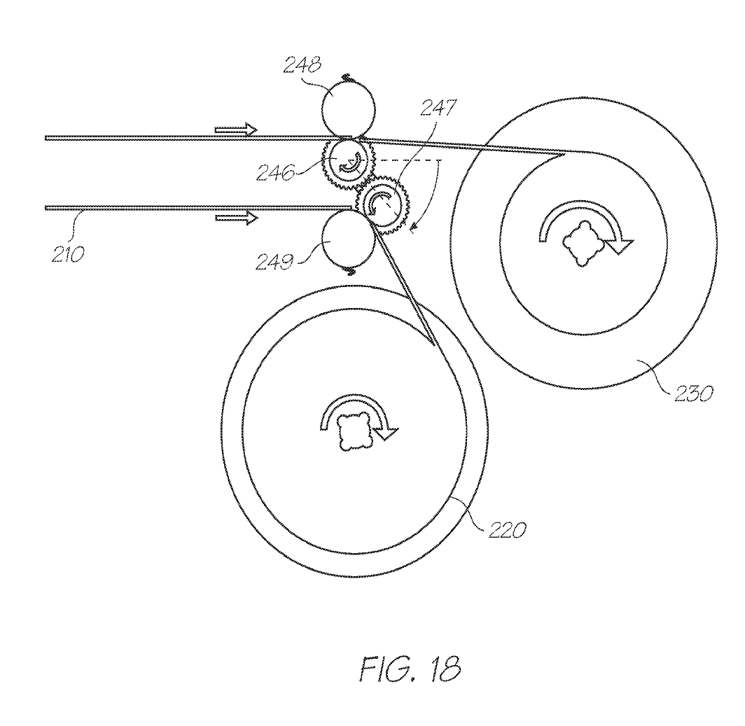

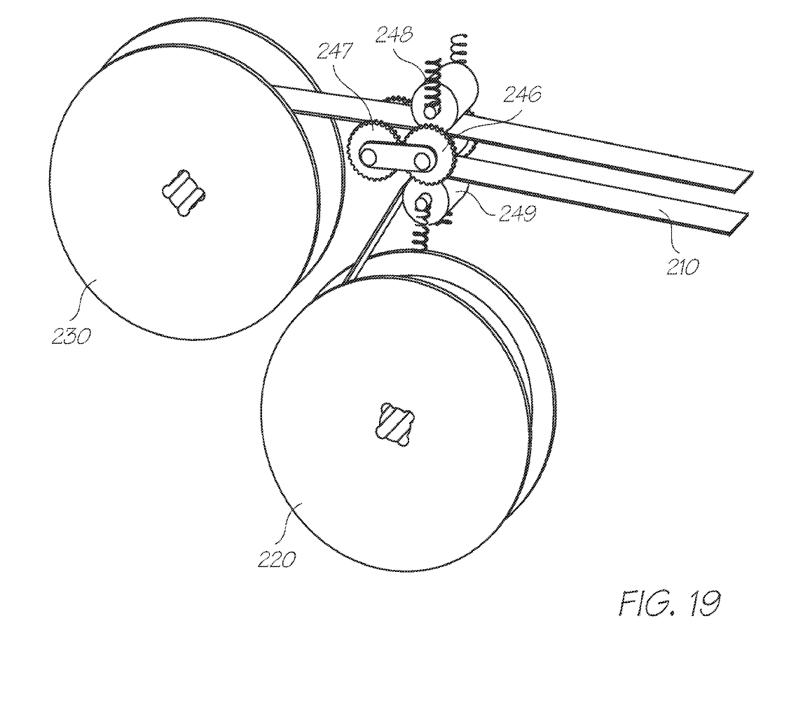

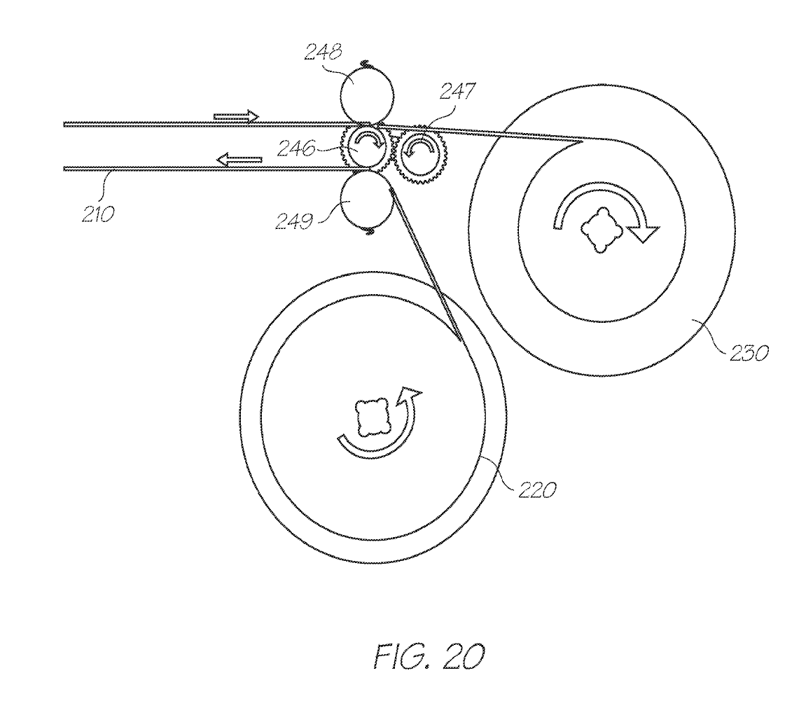

FIGS. 17 to 20 illustrate an alternative arrangement to selectively wind the strip 210 onto and from the supply reel 220 and the take-up reel 230. In this alternative arrangement reels 220 and 230 are spring loaded, exerting a constant torque to the reels 220 and 230 for winding the microfiber strip 210 onto the reels 220 and 230 respectively. The alternative arrangement illustrated in FIGS. 17 to 20 includes a motor 245 driving a gear-driven roller 246, with the motor 245 being micro-processor controlled. Motor 245 is not illustrated in FIGS. 18 and 20 to improve clarity. Gear-driven roller 246 in turn drives gear-driven roller 247 in a direction of rotation opposite that of gear-driven roller 246. The axis of gear-driven roller 247 is arranged to rotate about the axis of gear-driven roller 246 between the position illustrated in FIGS. 17 and 18, and the position illustrated in FIGS. 19 and 20. Rotation of the axis of gear-driven roller 247 about the axis of gear-driven roller 246 is effected by another drive means (not illustrated) under control of the micro-processor (not illustrated).

The alternative arrangement illustrated in FIGS. 17 to 20 further includes roller 248 urged against gear-driven roller 246, with the microfiber strip 210, extending between the take-up reel 230 and the carriage 300 (not illustrated in FIGS. 17 to 20), being fed between roller 248 and gear-driven roller 246. Roller 249 is provided for guiding the microfiber strip 210 extending between the supply reel 220 and the carriage 300. In the configuration illustrated in FIGS. 17 and 18 the roller 249 is urged against gear-driven roller 247, whereas in the configuration illustrated in FIGS. 19 and 20 the roller 249 is urged against gear-driven roller 248.

Since the direction of rotation of gear-driven roller 247 is opposite that of gear-driven roller 246, when the microfiber strip 210 extending between the supply reel 220 and the carriage 300 is driven by gear-driven roller 247 (ie. the configuration illustrated in FIGS. 17 and 18), and the microfiber strip 210 is fed by the motor 245 and gear-driven roller 246 towards the take-up reel 230, the microfiber strip 210 is also fed towards the supply reel 220 by gear-driven roller 247. This causes the carriage 300 to be pulled by the microfiber strip 210 towards the reels 220 and 230. In a similar manner, when the direction of rotation of motor 245 is reversed without change of configuration of the gear-driven roller 247, the microfiber strip 210 is fed away from the take-up reel 230 as well as away from the supply reel 220. This in turn causes the carriage 300 to move towards the opposite longitudinal end of the print head. The configuration illustrated in FIGS. 17 and 18 is used to control the movement of the carriage 300 away from and towards the reels 220 and 230 while keeping the microfiber strip 210 stationary relative to the carriage 300.

When the microfiber strip 210 extending between the supply reel 220 and the carriage 300 is driven by gear-driven roller 246 (ie. the configuration illustrated in FIGS. 19 and 20), and the microfiber strip 210 is fed by opposite sides of gear-driven roller 246. Accordingly, when the microfiber strip 210 is fed towards the take-up reel 230, then the microfiber strip 210 is simultaneously fed away from the supply reel 220. The configuration illustrated in FIGS. 19 and 20 is used to advance the microfiber strip 210 relative to the carriage 300 between subsequent wipes, thereby changing the portion of the microfiber strip 210 wiping the print face of the print head 100.

The print head maintenance system described herein has various advantages over the prior art. One such an advantage is that the wiping system avoids cross-contamination since each time the print head 100 is wiped, the print head 100 is wiped with a clean portion of the microfiber strip 210. Another advantage is that a need to provide a spittoon with a sump, and a mechanism to drain the sump, are avoided. The combined capper-platen 110 provides a compact arrangement, while the associated track arrangement 170 provides a simplified mechanism to control both the capper portion 112 and the platen portion 114 through linear movement of a single element, that being the track arrangement 170 being controlled by a single motor.

While the invention has been described with reference to specific embodiments, it is evident that many alternatives, modifications, and variations will be apparent to those skilled in the art. Accordingly, it is intended to embrace all such alternatives, modifications, and variations which fall within the scope of the appended claims.

1. A method for maintaining an elongate stationary printhead, the method comprising the steps of:
traversing a carriage lengthwise along the elongate stationary printhead, the carriage comprising a roller urged against the printhead and a strip of absorbent material having a wiping portion around the roller, such that the printhead is wiped by the absorbent material during movement of the carriage;
extending the strip of absorbent material lengthwise along the elongate stationary printhead during movement of the carriage, such that the strip of absorbent material opposes nozzles in the printhead after a traverse of the carriage; and
ejecting ink from the nozzles onto the strip of absorbent material opposing the nozzles.

2. The method of claim 1, wherein the strip around the roller remains stationary relative to the roller while the strip wipes the printhead.

3. The method of claim 1, wherein the strip of absorbent material is advanced, relative to the roller, between successive wipes of the printhead.

4. The method of claim 3, wherein the strip of absorbent material is fed from a supply reel, around the roller and onto a take-up reel.

5. The method of claim 4, wherein the supply reel and the take-up reel have respective rotation axes perpendicular to a longitudinal axis of the printhead.

6. The method of claim 1, wherein the strip of absorbent material which opposes the nozzles is spaced apart from the nozzles during the step of ejecting ink from the nozzles.

7. The method of claim 1, wherein the strip of absorbent material is a microfiber strip.
